(19) United States
(12) Patent Application Publication
(10) Pub. No.: US 2011/0095858 A1
(43) Pub. Date: Apr. 28, 2011

(54) CONVERTER ARRANGEMENT

(75) Inventor: Lubomir Spurny, Zdar Nad Saz (CZ)

(73) Assignee: Egston System Electronics Eggenburg GmbH, Eggenburg (AT)

(21) Appl. No.: 12/918,906

(22) PCT Filed: Feb. 19, 2009
(86) PCT No.: PCT/AT2009/000067

§ 371 Date: Dec. 17, 2010

(30) Foreign Application Priority Data
Feb. 22, 2008 (AT) A 302/2008

(51) Int. Cl. H01F 17/04

(52) U.S. Cl. 336/221

(57) ABSTRACT

In a converter arrangement (1) for generating an electrical voltage for an electrical and/or electronic circuit from the field of a primary conductor (6) through which current flows, comprising a first winding (2) around a first magnetic circuit (3), wherein the first magnetic circuit (3) has a first bushing (31) for the primary conductor (6), it is proposed, in order to prevent voltage spikes at output terminals (11) of the converter arrangement (1), that a second winding (4) around a second magnetic circuit (5) is connected in series with the first winding (2), wherein the second magnetic circuit (5) has a second bushing (51) for the primary conductor (6), that the first magnetic circuit (3) does not have an air gap, and that the second magnetic circuit (5) comprises at least one air gap (52).

The invention relates to a converter arrangement according to the preamble of patent claim 1.

Converter arrangements for generating an electrical voltage for an electrical circuit from the field of a primary conductor through which current flows are known, wherein a winding is wound around a core element and wherein the core element has a bushing for the primary conductor. The current-carrying primary conductor generates an electromagnetic field, wherein the field strength of the electromagnetic field increases with increasing current intensity. A winding is disposed around a magnetic circuit in the electromagnetic field around the primary conductor, with the result that energy can be withdrawn from the field, an electrical voltage being applied to terminals of the converter arrangement. The electrical voltage can be used in the circuit operatively connected to the terminals as supply voltage, as measuring voltage and/or as control voltage.

A disadvantage with this is that when there is a varying electrical current intensity of the current flow in the primary conductor, the electrical voltage also varies, in which case particularly in the case of short-circuit currents in the current-carrying primary conductor, very high electrical voltages can occur, and this can lead to damage to the electrical circuit.

It is therefore the object of the invention to provide a converter arrangement of the type specified initially with which the said disadvantages can be avoided and with which an electrical voltage can be obtained from the field of a current-carrying primary conductor, wherein without further expensive circuitry measures the electrical voltage is suitable for feeding and/or for supplying electrical and/or electronic circuits, with which the maximum electrical voltage of the converter arrangement is limited in a pre-determinable manner and can be kept substantially constant over a wide range of the current intensity.

According to the invention, this is achieved by the features of patent claim 1.

The advantage thus ensues that below a pre-definable current intensity in the primary conductor, the electrical voltage always increases proportionally with increasing current intensity, in particular steeply, and that the electrical voltage is configured to have an upper limit and in particular does not increase above a voltage magnitude that endangers or causes damage to the electrical and/or electronic circuit. In particular, in this case the electrical voltage can be substantially constant over broad ranges of current intensity, wherein the electrical and/or electronic circuit can be supplied safely and reliably with electrical voltage and can be operated safely and reliably over broad ranges of current intensity.

It is advantageous in this context that the converter arrangement can have an electrical maximum voltage at the terminals, which is not exceeded at any, in particular, arbitrarily high current intensity in the primary conductor, wherein the electrical maximum voltage can be in a pre-definable relationship to the nominal voltage. In particular, the maximum voltage can correspond to 1.1 times to 5 times, preferably 1.2 times to 3 times, particularly preferably 1.3 times to 2 times the nominal voltage.

It is advantageous in this context that even in the event of short-circuit currents in the primary conductor, the voltage is limited and the electrical circuit supplied by the voltage is not excessively loaded. As a result, in particular without expensive voltage limiting circuits, the electrical circuit can be operated reliably over a wide range of current intensity in the primary conductor.

The invention also relates to an electrical and/or electronic circuit according to the preamble of claim 16, which is operatively connected in terms of voltage, in particular supplied with voltage, by the converter arrangement according to the invention. The advantage thus ensues that the switching device can be configured simply, cost-effectively and in a space-saving manner. In particular, in such a manner additional safeguarding measures for safeguarding the electrical and/or electronic circuit from overvoltage can be dispensed with.

The dependent claims which in the same way as patent claim 1 at the same time form a part of the description relate to further advantageous embodiments of the invention.

The invention is described in detail with reference to the appended drawings in which merely preferred embodiments are shown as an example, wherein:

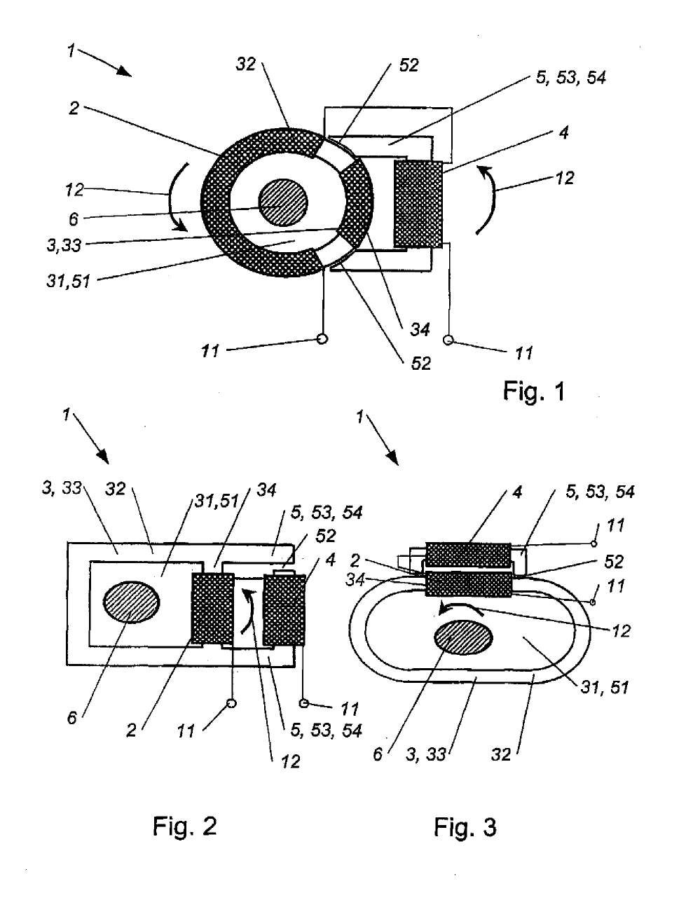

FIG. 1 shows a schematic front view of the converter arrangement in a first preferred embodiment and the primary conductor cut parallel to the cross-section;

FIG. 2 shows a schematic front view of the converter arrangement in a second preferred embodiment and the primary conductor cut parallel to the cross-section;

FIG. 3 shows a schematic front view of the converter arrangement in a third preferred embodiment and the primary conductor cut parallel to the cross-section;

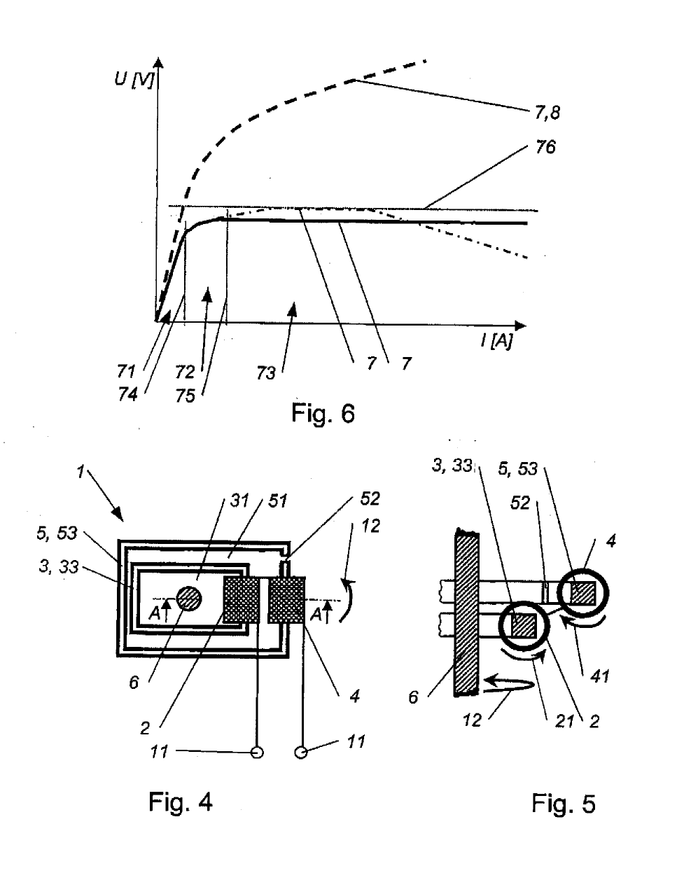

FIG. 4 shows a schematic front view of the converter arrangement in a fourth preferred embodiment and the primary conductor cut parallel to the cross-section;

FIG. 5 shows a schematic view of the converter arrangement from FIG. 4 cut along the line A-A; and

FIG. 6 shows a voltage-current diagram which depicts schematically a working curve of a conventional converter arrangement, not shown, and two different working curves of different preferred embodiments of the converter arrangement.

FIGS. 1 to 5 show various preferred embodiments of a converter arrangement 1 for generating an electrical voltage for an electrical and/or electronic circuit from the field of a current-carrying primary conductor 6, comprising a first winding 2 around a first magnetic circuit 3, wherein the first magnetic circuit 3 has a first bushing 31 for the primary conductor 6, wherein in order to prevent excess voltages at terminals 11 of the converter arrangement 1, it is provided that a second winding 4 around a second magnetic circuit 5 is connected in series with the first winding 2, wherein the second magnetic circuit 5 has a second bushing 51 for the primary conductor 6, that the first magnetic circuit 3 is configured free from air gaps and that the second magnetic circuit 5 has at least one air gap 52.

The advantages and effects specified initially can be ensured by means of the converter arrangement 1, whereby the advantage ensues that below a pre-definable current intensity in the primary conductor 6, the electrical voltage in particular always increases proportionally with increasing current intensity in the primary conductor 6, in particular steeply, and at the same time even at high and maximum currents in the primary conductor 6, the voltage at the terminals 11 of the converter arrangement does not increase above a pre-determinable voltage magnitude, in particular above a pre-definable maximum voltage 76.

It is advantageous in this context that even with short-circuit currents in the primary conductor 6 which can be 100 times, 1000 times, 10 000 times or 100 000 times the nominal current intensity in normal operation of the primary conductor 6, the voltage is limited with the result that the electrical and/or electronic circuit supplied by the voltage is not excessively loaded. As a result, the electrical and/or electronic circuit, can be operated reliably, in particular, without expensive voltage limiting circuits, at strongly varying current intensities, in particular at current intensities which vary by a factor of 10 to 100 000, in particular by a factor of 50 to 15 000, preferably by a factor of 200 to 2000, in the primary conductor 6. It can thus be ensured that even at low current intensities in the primary conductor 6, the converter arrangement 1 delivers a sufficiently high voltage for operating the electrical and/or electronic circuit to the terminals 11 and/or that the nominal current intensity in the primary conductor 6 can be configured to be particularly low. The advantage thus ensues that below a pre-definable first current intensity 74 in the primary conductor 6 the electrical voltage can be configured to always increase proportionally with increasing current intensity, in particular steeply, and that above a pre-definable second current intensity 75 in the primary conductor 6 the electrical voltage at most increases slightly, in particular remains substantially constant and/or becomes lower with a small negative increase, wherein the voltage at every current intensity in the primary conductor 6 is lower than the pre-definable maximum voltage 76. In this case, the pre-definable maximum voltage 76 can be selected in particular below a voltage level which endangers or damages the electrical and/or electronic circuit, wherein the electrical and/or electronic circuit can be supplied safely and reliably with electrical voltage and can be operated safely and reliably over wide ranges of current intensity.

At the pre-definable nominal current intensity of the current intensity in the primary conductor 6 which is defined by the normal operation of the converter arrangement 1 at a normal current intensity in the primary conductor 6, a pre-definable nominal voltage can be applied to the terminals 11 of the converter arrangement 1, which is below the electrical maximum voltage 76. The highest maximum voltage 76 applied to the terminals 11 can be in a pre-definable relationship to the nominal voltage. In particular, the maximum voltage 76 can correspond to 1.1 times to 5 times, preferably 1.2 times to 3 times, particularly preferably 1.3 times to 2 times the nominal voltage.

This ratio of electrical nominal voltage to electrical maximum voltage 76 can advantageously be controlled in a pre-determinable manner by means of the size of the air gap 52 arranged in the second magnetic circuit 5 and by means of the ratio of a first number of turns of the first winding 2 to a second number of turns of the second winding 4. It can then be provided in particular that the air gap 52 is configured to be between 0.01 mm and 0.5 mm wide.

In particular, it can be provided that the ratio of the first number of turns of the first winding 2 to the second number of turns of the second winding 4 is between 2:1 and 1:2.

In particular, it can be provided that the first magnetic circuit 3 comprises at least one first core element 33, which first core element 33 is configured to enclose the primary conductor 6 free from gaps. In particular, it can be further provided that the second magnetic circuit 5 comprises at least one second core element 53 having the air gap 52, which second core element 53 is configured to enclose the primary conductor 6 with an air gap. It is advantageous in this case that even in the event of a short-circuit current in the primary conductor 6, the voltage at the terminals 11 is limited, in particular is at the most equal to the pre-definable maximum voltage 76, whereby the electrical and/or electronic circuit operatively connected to the terminals 11 is not excessively overloaded. As a result, the electrical and/or electronic circuit can be operated reliably and protected from excess voltages, in particular without expensive voltage limiting circuits.

The primary conductor 6 in particular has an electrical current configured as an alternating current flowing therethrough. The alternating current in particular has nationally or internationally usual frequencies, in particular 16.6 Hz, 50 Hz or 60 Hz, in which case the field, in particular the vector field, of the current-carrying primary conductor 6 varies periodically with the same frequency. In this case, the alternating current can be configured as any type of alternating current, in particular rectangular or sawtooth shaped, wherein the current intensity information of the alternating current corresponds to the current intensity of a direct current having the same effect. In particular, the alternating current can be sinusoidal. The term current intensity here means the intensity of the electrical current and is measured in amps.

The converter arrangement 1, insofar as the primary conductor 6 has current flowing therethrough, is suitable and/or provided for converting the available energy in the electromagnetic field around the electrical primary conductor 6. In this context, the current intensity in the primary conductor 6 is the input quantity of the converter arrangement 1 and the voltage applied to, and especially between, the two terminals 11 of the converter arrangement 1 is the output quantity of the converter arrangement 1, where the converter arrangement 1 effects the conversion of energy produced by the current flow in the primary conductor 6 of a field formed around the primary conductor 6 into the voltage. This conversion between the current intensity into the voltage can in particular obey a uniquely pre-definable transfer function of the converter arrangement 1, wherein the transfer function of the converter arrangement 1 can be given as the working curve 7 of the converter arrangement 1 in tabular form, in the form of a formula relationship and/or graphically.

The working curve 7 can in particular be configured approximately according to the working curve 7 depicted by the continuous line in FIG. 6 if the first number of turns and the second number of turns are approximately the same. The first number of turns and the second number of turns are approximately the same if the first number of turns is plus/minus 20% of the second number of turns, whereby it can be ensured that the maximum voltage 76 is not exceeded. The first number of turns and the second number of turns are substantially the same if the first number of turns is plus/minus 5% of the second number of turns, whereby it can be particularly reliably ensured that the maximum voltage 76 is not exceeded.

The working curve 7 can in particular be configured approximately according to the working curve 7 depicted by the dot-dash line in FIG. 6 if the first number of turns is at least 20% lower than the second number of turns. In this case it can be reliably ensured that the electrical voltage applied to the terminals 11 of the converter arrangement 1 substantially decreases continuously from and above a pre-determinable current intensity.

It can preferably be provided that a first winding voltage can be formed in the first winding 2 and a second winding voltage can be formed in the second winding 4 wherein at a pre-definable current flow through the primary conductor 6, the first winding voltage and the second winding voltage are configured to partially compensate for each other, wherein—when viewed in the direction of current flow between the two contacts 11—the first winding voltage and the winding voltage counteract one another, i.e. that—in a pre-determinable electrical direction of rotation—the first winding voltage is positive and the second winding voltage is negative. The electrical voltage applied between the two output terminals 11 is configured as the sum of the positive first winding voltage and the negative second winding voltage and—provided that the applied voltage is non-zero—the magnitude of the electrical voltage is always smaller than the magnitude of the first winding voltage or the magnitude of the second winding voltage. Since this voltage provided for supplying the electrical and/or electronic circuit is configured as the sum voltage of the first winding voltage and the second winding voltage and is applied between the terminals 11, this electrical voltage can be designated as sum voltage, as total voltage and/or as output voltage of the converter arrangement 1. In this case, the first winding voltage and the second winding voltage can increase continuously with increasing current intensity in the primary conductor, wherein the two winding voltages counteract one another in the series circuit and compensate for one another, at least in part. The advantage thus ensues that the working curve can be adapted precisely and individually according to the requirements, wherein in particular at very high current intensities in the primary conductor 6, for example at around 3000 A, in particular at around 30 000 A, preferably at 300 000 A and above, the electrical voltage can be configured to be smaller than or the same as the safe maximum voltage 76 for the electrical and/or electronic circuit.

In this case, the first winding voltage and/or the second winding voltage can increase above the pre-definable value of the maximum voltage 76, wherein the first winding 2 and/or the second winding 4 are designed in particular for this increase in the first winding voltage or the second winding voltage. It thus be ensured that even at high current intensities in the primary conductor 6, the first winding 2 and/or the second winding 4 are not damaged and that the converter arrangement 1 can be used free from disturbance over a large range of current intensities, for example, between 0 A and 300 000 A, in particular between 0 A and 50 000 A, preferably between 0 A and 10 000 A.

FIG. 1 shows the converter arrangement 1 of a preferred first embodiment. In this preferred embodiment, the first magnetic circuit 3 can be configured substantially as a toroidal first core element 33, wherein the first bushing 31 is configured for passage of the primary conductor 6 at the centre of the first core element 33. The first winding 2 can extend approximately over three quarters of a circumference of the first core element 33 surrounding the first bushing 31.

It is preferably provided that the first core element 33 is configured to surround the primary conductor 6, at least in certain areas.

The first core element 33 can in particular be made of a first material which reduces the magnetic reluctance and can in particular comprise transformer sheet metal, pure iron, ferrite, rolled plate and/or dynamo sheet metal or combinations of these materials.

It can preferably be provided that the second magnetic circuit 5 comprises at least one second core element 53.

As shown in FIG. 1, the second core element 53 can preferably be configured as a partial segment 54 for placement onto the first core element 33. At the same time, as shown in the preferred first embodiment, the second magnetic circuit 5 can comprise a partial region 32 of the first core element 33 and a partial segment 54 placed onto the first core element 33, wherein in particular two air gaps 52 can be formed between the first core element 33 and the partial segment 54, wherein the second magnetic circuit 5 can in particular have two air gaps 52 of pre-determinable width. The second winding 4 is wound around the second core element 53 configured as partial segment 54. As a result, the converter arrangement 1 can be constructed very compactly, in a space-saving manner and cost-effectively.

It can preferably be provided that the first core element 33 and/or the second core element 53 comprises at least one core plate, and is configured in particular as a laminated core. In this case, the magnetic preferred direction of the core plate, in particular of the laminated core, can coincide with the direction of rotation of the first core element 33 and/or the second core element 53 about the first opening 31 or the second opening 51. A particularly high efficiency of the first magnetic core 3 and/or the second magnetic core 5 can thus be ensured.

In particular, in an advantageous further development, it can be provided that the first core element 33 and/or the second core element 53 is homogeneous, and is configured in particular to be homogeneous in the direction of rotation about the first bushing 31 or the second bushing 51. In this case, the first core element 33 can preferably comprise a plurality of layers of a transformer plate and can efficiently concentrate the field lines of the electromagnetic field and ensure a high efficiency of the first winding 2. As a result of the substantially toroidal geometry, i.e. the round configuration of the first core element 33 along the circumference around the first bushing 31, scattering losses can be low and the first magnetic circuit 3 can be formed with a high efficiency. The cross-sectional area of the first core element 3, which is disposed substantially normally to the circumferential direction of the first core element 33, can be configured to be circular, square, polygonal, in particular tetragonal or hexagonal and/or oval as well as solid or hollow. The cross-sectional area of the second core element 53, which is disposed substantially normally to the circumferential direction of the second core element 53, can be configured to be circular, square, polygonal, in particular tetragonal or hexagonal and/or oval as well as solid or hollow.

In a further advantageous embodiment, shown schematically in FIGS. 4 and 5, the second core element 53 can be configured to enclose the primary conductor 6, at least in certain areas. As a result, the first magnetic circuit 3 and the second magnetic circuit 5 can be mounted and dismounted independently of one another in the region of the primary conductor, with the result that the assembly and maintenance of the converter arrangement 1 can be simplified.

In an alternative embodiment, not shown, it can be provided that the first core element 33 is wound substantially completely along the circumference. As a result, the efficiency of the first magnetic circuit 3 and of the first winding 2 can be particularly high.

Likewise, the conductor of the windings 2, 4 can have a particularly large cross-section. As a result the inherent resistance of the first winding 2 and/or of the second winding 4, in particular of the entire converter arrangement 1, can be low.

FIG. 2 shows a second preferred embodiment of the converter arrangement 1. The first magnetic circuit 3 and the second magnetic circuit 5 are in this case preferably formed from one or more stamped magnetic sheets which can be placed one above the other in multiple layers in the direction of longitudinal extension of the primary conductor 6. In this case, the first magnetic circuit 3 is formed without an air gap 52. The second magnetic circuit has precisely one air gap 52 of pre-determined width. The first winding 2 and the second winding 4 are connected in series, in an electrically opposite manner, i.e. opposite to one another.

FIG. 3 shows a third preferred embodiment of the converter arrangement 1. The first magnetic circuit 3 is again formed from the first core element 33. The second magnetic core 5 is formed from the section 54 and a large part of the first core element 33. The first winding 2 wound around the core element 33 and the second winding 4 wound around the section 54 are connected electrically in series.

In the first preferred embodiment, the second preferred embodiment and the third preferred embodiment of the converter arrangement 1 it is preferably provided that the second magnetic circuit 5 comprises a partial region 32 of the first magnetic circuit 3 and a partial segment 54 operatively connected to the partial region 32 of the first magnetic circuit 3 and that the first bushing 31 and the second bushing 51 are configured as a bushing for the primary conductor 6. In this case, both the magnetic flux of the first magnetic circuit 3 and the magnetic flux of the second magnetic circuit 5 flow in the partial region 32 of the first magnetic circuit 3. In another partial region 34 of the first magnetic circuit 3 which in particular can be disposed parallel to the section 54, only the magnetic flux of the first magnetic circuit 3 flows. In this case, the converter arrangement 1 can be configured to be particularly compact and particularly space-saving.

Preferably, as shown in FIG. 1, the first winding 2 can be wound in a multi-part manner, wherein in particular the first winding can be wound partially around the partial region 32 and partially around the further partial region 34. As a result, the efficiency of the first winding and of the first magnetic circuit 3 can be configured to be particularly high. Multi-part winding means in this case that the turns of the respective winding, that is of the first winding 2 and/or the second winding 4, are not wound immediately successively but rather, when viewed along the winding wire, after a pre-determinable number of first turns, the winding wire is guided unwounded in sections, then a pre-determinable number of at least one further turn is wound.

It has proved to be particularly advantageous if, when viewed in the direction of winding, initially the first number of turns of the first winding 2 is wound, then the winding wire is guided for winding the second winding 4, then the second winding 4 is wound, then the winding wire is guided for winding a second number of turns of the first winding 2 and the second number of turns of the first winding 2 is wound. The number of turns of the first winding 2 corresponds in this case to the sum of the first number and the second number, wherein the first number and the second number in particular can be approximately the same. In this case, the first winding 2 is wound in two parts and the second winding 4 is wound in one part and the second winding 2, when viewed in the winding direction of the winding wire, is disposed between the first part of the first winding 2 and between the second part of the first winding 2. To this end, it can advantageously be provided that the first winding 2 is wound at least in two parts and the second winding 4, when viewed in the winding direction of the winding wire, is disposed inside the first winding 4. It is particularly advantageous in this case if the first winding voltage is divided into two regions spaced apart from one another on the winding wire, when viewed in the winding direction of the winding wire, and is thereby divided into lower partial voltages. The electrical voltage of the converter arrangement 1 is in this case composed of the sum of the positive first of the two partial voltages of the first winding 2, the negative second winding voltage and the second of the two partial voltages of the first winding 2. It is advantageous in this case that a particularly high resistance to short-circuiting of the converter arrangement 1 and in particular of the first winding 2 can be ensured.

Alternatively, it can be provided that the first winding 2 and/or the second winding 4 are wound in a multi-part manner. As a result, the available installation space can individually be optimally utilised and filled with the converter arrangement 1, in particular with winding wire. In this case, it can be provided in particular that the first winding 2 can be wound in three parts and comprises a first part of the first winding 2, a second part of the first winding 2 and a third part of the first winding 2 and that the second winding 4 can be wound in two parts and comprises a first part of the second winding 4 and a second part of the second winding 4 and that, when viewed in the winding direction of the winding wire, successively, the first part of the first winding 2, the first part of the second winding 4, the second part of the first winding 2, the second part of the second winding 4 and the third part of the first winding 2 are wound. In this sense, it can be provided in particular that the first winding 2 is wound at least in three parts, that the second winding 4 is wound at least in two parts and that, when viewed in the winding direction of the winding wire, respectively at least one part of the second winding 4 is disposed between respectively two parts of the first winding 2. In this sense, the number of parts of the first winding 2 can be at least four and the number of parts of the second winding 4 can be the number of parts of the first winding 2 minus one. Likewise, it can be provided that the first winding 2 and the second winding 4 are wound in two parts, the number of parts of the first winding 2 and the second winding 4 being the same. In all these possible embodiments of a multi-part first winding 2 and second winding 4, it is advantageous that both the first winding voltage and also the second winding voltage can be divided into a plurality of partial voltages and in particular substantially into pre-determinably many partial voltages, with the result that even at very high current intensities in the primary conductor 6, for example, above 100 000 A, the corresponding partial voltages can remain particularly low and therefore the resistance to short-circuiting of the first winding 2 and the second winding 4 can be particularly reliably ensured. The converter can be provided, for example, for application in power plants.

The partial region 32 can advantageously be configured with a particularly low magnetic reluctance, for example, by increasing the cross-section or by increasing the permeability of the material used, so that this region has only a low magnetic reluctance, i.e. a high magnetic conductivity. As a result, particularly if the first core element 3 and the second core element 5 are jointly formed by the partial region 32, in certain areas, a high efficiency of the converter arrangement 1 can be ensured.

According to the preferred first embodiment, the first winding 2 is wound, at least in certain areas, in particular substantially around the partial region 32 of the first magnetic circuit 3, in particular of the first core element 33.

In a preferred second and third embodiment, according to FIG. 2 and FIG. 3, the first winding 2 is wound, at least in certain areas, in particular substantially around the further partial region 34 of the first magnetic circuit 3, in particular of the first core element 33.

In the preferred converter arrangements 1, the first winding 2 can form the main winding, which in particular operates with high efficiency and the second winding 4 can form the compensating winding, wherein the limitation of the voltage below or at the maximum voltage 76 can be ensured by the cooperation of the first winding 2 and the second winding 4, in particular the at least partial compensation of the first winding voltage and the second winding voltage.

It can preferably be provided that the electromagnetic effect, in particular the second winding voltage, of the second winding 4 at least partially compensates for the electromagnetic effect, in particular the first winding voltage, of the first winding 2. At the same time, it can preferably be provided that the electromagnetic effect, in particular the second winding voltage, of the second winding 4 substantially counteracts the electromagnetic effect, in particular the first winding voltage, of the first winding 2.

It can preferably be provided in this case that at a pre-definable current flow through the primary conductor 6 the first magnetic circuit 3 is configured to form a first magnetic flux and the second magnetic circuit 5 is configured to form a second magnetic flux which differs from the first magnetic flux. In this case, the first winding voltage and the second winding voltage can differ from one another at a pre-definable current flow.

It can advantageously be provided that the first magnetic circuit 3 has a first magnetic total reluctance and the second magnetic circuit 5 has a second magnetic total reluctance which differs from the first magnetic total reluctance, in particular is greater. The first magnetic circuit 3 has a magnetic working curve which differs from the second magnetic circuit 5, wherein the second magnetic circuit 5, which has an air gap 52, saturates at a different current intensity in the primary conductor 6 compared with the air-gap-free first magnetic circuit 3. It is advantageous here that the working curve 7 of the converter arrangement 1 can be adapted in such a manner to the respective individual requirements.

At the same time, it can be provided that the first magnetic circuit 3 has a first equivalent permeability and the second magnetic circuit 5 has a second equivalent magnetic permeability which differs from the first equivalent permeability, in particular is smaller. The equivalent permeability is calculated as the averaged permeability of the respective magnetic circuit 3, 5 and is a measure for the conductivity of this magnetic circuit 3, 5. As the equivalent permeability increases, the magnetic total reluctance decreases, with the other parameters such as cross-section, length of the magnetic circuit and width of the air gap 52 remaining the same.

Due to the mirror-inverted superposition, in particular the partial compensation, the working curve 7 of the converter arrangement 1 can be individually adapted to the respective requirements. The voltage applied to the terminals 11 can be provided as a supply voltage, as a measuring voltage and/or as a control voltage for electrical and/or electronic circuits, with the result that the electrical and/or electronic circuits, in particular the electrical and/or electronic loads such as, for example, storage circuits, evaluation devices and/or control circuits can be configured free from further supply voltages and free from further connecting lines. As a result, further voltage supplies can be dispensed with.

In multiphase primary sources, a converter arrangement 1 can be configured in particular at each phase. In the case of three-phase current, which usually has three phases, the neutral conductor and if appropriate, an earth, for example, preferably three converter arrangements 1 can be operated in parallel. The three converter arrangements 1 can advantageously also deliver three-phase current.

FIG. 4 shows a schematic front view of a fourth preferred embodiment of the converter arrangement 1. The two magnetic circuits, i.e. the first magnetic circuit 3 and the second magnetic circuit 5, are configured at a distance from one another. The first magnetic circuit 3 comprises the first core element 33 which preferably comprises one or more first materials. The second magnetic circuit 5 comprises the second core element 53 which preferably comprises one or more second materials. The first winding 2 is the first core element 33 and the second winding 4 is wound around the second core element 53. The first winding 2 and the second winding 4 are connected in series, the voltage of the converter arrangement 1 being present at the terminals 11.

FIG. 5 shows the fourth preferred embodiment in cutaway side view along the line A-A depicted in FIG. 4. The primary conductor 6 is shown cutaway along the longitudinal extension. The first core element 33 and the second core element 53 are shown in cutaway view. The first winding 2 and the second winding are in particular connected in series in such a manner that—when viewed in a common direction of rotation 12 of the first magnetic circuit 3 about the first bushing 31 and of the second magnetic circuit 5 about the second bushing 51—in a pre-definable direction of current flow through the primary conductor 6 the current flow of the first winding 2 about the wound cross-section of the first magnetic circuit 3 takes place in a first direction of rotation 21 and the current flow of the second winding 4 about the wound cross-section of the second magnetic circuit 5 takes place in a second direction of rotation 41 opposite to the first direction of rotation 21. As a result, the electromagnetic effects can be partially mutually compensated particularly easily. In particular, the first winding voltage and the second winding voltage can thereby at least be partially mutually compensated in a particularly simple way.

Preferably, it can be provided that the first winding 2 and the second winding 4 have the same number of turns. As a result, the voltage at the terminals 11 can be substantially constant over large ranges of the current intensity in the primary conductor 6, i.e. can be kept in the range of plus/minus 15 percent about an average of the voltage in this range.

In the first to fourth preferred embodiment of the converter arrangement 1, it can also be provided that the number of turns of the first winding 2 is greater than the number of turns of the second winding 4. As a result, from a pre-definable current intensity in the primary conductor 6, the voltage can be configured to be decreasing again, in which case the output signal of the converter arrangement 1 applied as voltage to the terminals 11 will be lower as the current intensities become higher. It can thus be ensured that even at very high current intensities in the primary conductor 6, for example, 150 000 A, in particular 300 000 A, preferably over 500 000 A, no voltage above the pre-definable maximum voltage occurs, wherein in particular the safety, that is the distance of the voltage actually applied to the terminals 11 from the pre-definable maximum voltage 76, increases with increasing current intensity.

Working curves 7 of converter arrangements 1 according to the invention and conventional converter arrangements can be depicted graphically in a voltage-current diagram which is shown schematically in FIG. 6. The working curve 7 is defined as the electrical voltage applied between the terminals 11 as a function of the current intensity flowing through the bushings 31, 51, in particular the current intensity in the primary conductor 6.

FIG. 6 shows schematically three different working curves 7, where the profiles of the working curves 7 serve the purpose of qualitative illustration and since they are schematic, do not represent any quantitative relationships between the working curves.

A normal working curve 8 of a conventional converter arrangement configured as working curve 7 is shown by the dashed line. The normal working curve 8 increases continuously with increasing current intensity in the primary conductor 6, wherein the electrical voltage increases continuously so that with increasing current flow in the primary conductor, the voltage delivered by the conventional converter arrangement increases still further and wherein in particular with short-circuit currents in the primary conductor, a voltage above 1000 V can occur as the output voltage of the converter arrangement.

For this reason in electrical and/or electronic circuits supplied with voltage in such a manner, a frequently expensive, cost-intensive and space-consuming excess voltage protection is usually essential.

The working curves 7 can be calculated and/or measured, a constant ohmic load being connected to the terminals 11 or assumed in the calculation. When measuring the working curve 7, the current intensity in the primary conductor 6 can be increased between, for example, 0 A and for example, 300 000 A in pre-determined steps and the respectively relevant voltage applied to the terminals 11 can be measured, thus giving measured voltage points. The measured voltage points can be plotted versus current intensity in a two-dimensional voltage-current diagram, so that the working curve 7 of the converter arrangement 1 can be determined and/or approximated.

The working curves 7 shown schematically in FIG. 6 can advantageously be divided into three regions. The first working curve region 71 can be configured as a first linear region in which the voltage of the converter arrangement 1 applied at and between the terminals 11 increases substantially linearly proportionally, in particular steeply, with the current intensity. The first working curve region 71 can be formed, for example, in the current intensity range between 0 A and a pre-definable first current intensity 74, for example 50 A. As a result, the converter arrangement 1 can be reliably used at the current intensities usual in buildings, and in halls and industry.

The second working curve region 72 of the working curves 7, adjoining the first working curve region 71, can be formed as a transition region. In the second working curve region 72, the working curve 7 in the voltage-current diagram can flatten out continuously, the slope of the working curve 7 decreasing continuously with increasing current intensity. Advantageously the slope of the working curve 7 at the end of the transition region can be substantially zero, in which case a second current intensity 75 can form the upper limit of the transition region. In this region strong compensation of the first winding voltage and the second winding voltage is already beginning. The second working curve region 72 can be formed between the first current intensity 74 and the second current intensity, for example 150 A.

The nominal current intensity of the converter arrangement 1, i.e. the current intensity in the primary conductor 6 in normal operation of the converter arrangement 1, can be located for example in the transition region. As a result, the permanent voltage supply of the electrical and/or electronic circuit connected to the converter arrangement 1 can be ensured, wherein the voltage at the terminals 11 varies only slightly, for example, by a maximum of plus/minus 40 percent, in particular by a maximum of plus/minus 30 percent when the current intensities within the transition region vary.

The third working curve region 73 adjoining the second working curve region 72 can be designated as compensating region. In this region the first winding voltage and the second winding voltage compensate for one another in such a manner that the voltage substantially remains largely constant in this region at the terminals 11 regardless of the current intensity in the primary conductor 6, for example it varies by less than plus/minus 25 percent, in particular by less than plus/minus 15 percent. The third working curve region 73 can preferably be formed above the pre-definable second current intensity 75.

In particular, it can be provided that the nominal current intensity is provided in the third working curve region 73 of the working curves 7, wherein the nominal current intensity is greater than the pre-definable second current intensity 75. In such a manner the voltage of the converter arrangement 1 at the terminals 11 can vary particularly little in the presence of variations of the current intensity about the nominal current intensity, in particular can be substantially constant. In particular, the first current intensity 74, the second current intensity 75 and the nominal current intensity are determined by the pre-definable parameters of the converter arrangement 1 and can be noted together with the respectively relevant voltage for example in a data sheet as a characteristic of the converter arrangement 1.

FIG. 6 shows two different preferred working curves 7 of the converter arrangement 1 which differ in particular in the third working curve region 73. The preferred working curve 7 shown by a solid line shows a substantially constant voltage profile in the third working curve region 73.

The preferred working curve 7 shown by a dot-dash line shows a slightly small rise as far as a maximum which can preferably correspond to the maximum voltage 76 of the converter arrangement 1, and a subsequent decay of the voltage with increasing current intensity in the primary conductor 6, wherein the decay can merely be formed with a small slope and wherein the voltage can decrease to a pre-determinable minimum voltage or as far as zero volts.

In this connection, it can be provided that at very high current intensities, for example above 20 000 A, the voltage of the converter arrangement 1 drops towards zero volts. As a result, the safety distance between the voltage and the maximum voltage 76 of the converter arrangement 1 can be increased.

In particular, the maximum value and/or the maximum voltage 76 can be pre-definably configured by the converter arrangement 1 and can be, for example, about 35 V, in particular about 25 V, preferably about 15 V. In such a manner a voltage overload of the electrical and/or electronic circuit connected to the terminals of the converter arrangement 1 can be effectively avoided. The electrical and/or electronic circuits, in particular the loads, can thus be supplied and/or controlled with a limited, in particular slightly fluctuating voltage in the case of a strongly fluctuating current flow in the primary conductor 6.

In other advantageous embodiments of the working curve, the maximum value and/or the maximum voltage 76 can be valid up to a predetermined current intensity, wherein the predetermined current intensity can be between 3000 A and 50 000 A, in particular between 5000 A and 30 000 A, preferably between 10 000 A and 20 000 A, or wherein the predetermined current intensity can be 20 times to 300 times, in particular 35 times to 200 times, preferably 50 times to 150 times the nominal current intensity and wherein the voltage above the pre-definable current intensity increases above the maximum voltage 76.

It is advantageous that the voltage up to the predetermined current intensity can have a particularly constant profile and thus, over a broad range of current intensity a substantially constant voltage is applied to the converter arrangement 1. The region in which the voltage begins to increase above the maximum voltage 76 is in this case in a current intensity range far removed from the current intensity range at the nominal current and can be prevented by simple means, in particular with a current cut-out switch in the primary conductor 6.

The voltage generated by the converter arrangement 1, i.e. the output signal of the converter arrangement 1, can be used in particular as a proportional measuring signal and enables the current intensity to be inferred, i.e. the input signal of the converter arrangement 1, wherein at the same time the voltage, and therefore the maximum measurement signal, has an upper limit and it can thus be ensured that the downstream evaluation device is not damaged by a too-large measurement signal, for example, in the event of a short-circuit current in the primary conductor 6. For this purpose, preferably the nominal current intensity can be provided in the first working curve region 71 of the working curve 7 of the converter arrangement 1.

It is advantageous in this context that insofar as the voltage delivered by the converter arrangement 1 at a pre-definable current intensity increases above the maximum voltage 76, that this voltage can be used as a trigger voltage for other electrical components, in particular the voltage cut-out switch. As a result, the converter arrangement 1 can ensure both a substantially constant voltage in the current intensity range below the pre-definable current intensity and a mains disconnection of the primary conductor 6 at the pre-definable current intensity. As a result, the converter arrangement 1 can have two functions, so that additional components and installation space can be saved.

The working curve 7, in particular the voltage at the first current intensity 74, the voltage at the second current intensity 75 and the voltage at the nominal current intensity can be pre-determined by means of the number of turns of the first winding 2, the second winding 4, the first magnetic total reluctance, the second magnetic total reluctance, the first equivalent permeability and/or the second equivalent permeability which can preferably form pre-definable parameters of the converter arrangement 1. In addition, the profile of the working curve 7 in the first working curve region 71, in the second working curve region 72 and in the third working curve region 73 of the working curve can be pre-defined, with the result that the transfer function of the converter arrangement 1—in the case of constant frequency, in particular 50 Hz of the alternating current of the current flow in the primary conductor and in the case of constant, in particular ohmic, load at the terminals 11—can be completely and substantially uniquely pre-determined and wherein the working curve 7 can be easily and flexibly adapted to the individual requirements of the primary conductor 6, the nominal current intensity, and/or the electrical and/or electronic circuit.

For simple compensation of the electromagnetic effects of the first winding 2 and the second winding 4, it can particularly preferably be provided that, when viewed in a common direction of rotation 12 of the first magnetic circuit 3 about the first bushing 31 and of the second magnetic circuit 5 about the second bushing 51, in a pre-definable direction of current flow through the primary conductor 6 the current flow of the first winding 2 about the wound cross-section of the first magnetic circuit 3 takes place in a first direction of rotation 21 and the current flow of the second winding 4 about the wound cross-section of the second magnetic circuit 5 takes place in a second direction of rotation 41 opposite to the first direction of rotation 21.

In a preferred embodiment, the converter arrangement 1 can be comprised of an electrical and/or electronic circuit, in particular a circuit comprising an energy storage device, wherein the circuit is operatively connected to the converter arrangement 1 in terms of voltage, in particular is supplied with voltage. The terminals 11 are preferably operatively connected to the electrical and/or electronic circuit. Advantageously the electrical and/or electronic circuit can be comprised of a switching device, in particular the storage switching device for interrupting a current flow. The switching device can thus be configured simply and without further overvoltage protection devices, wherein the supply voltage and/or the measuring voltage of the switching device is produced from the field of the current-carrying primary conductor 6.

Further embodiments according to the invention exhibit only some of the described features, wherein any feature combination, in particular of different described embodiments can be provided.

1.-18. (canceled)

19. A converter arrangement for generating an electrical voltage for an electrical and/or electronic circuit from a field of a current-carrying primary conductor, said converter arrangement comprising:
a first winding around a first magnetic circuit having a first bushing for the primary conductor, said first magnetic circuit being configured free from air gaps, wherein a first winding voltage can be formed in the first winding;
a second winding disposed around a second magnetic circuit and connected in series with the first winding, said second magnetic circuit having a second bushing for the primary conductor and at least one air gap, wherein a second winding voltage can be formed in the second winding;
wherein at a pre-definable current flow through the primary conductor the first winding voltage and the second winding voltage are configured to partially compensate for each other,
wherein below a pre-definable first current intensity in the primary conductor the electrical voltage increases proportionally with increasing current intensity, and from a pre-definable second current intensity which is greater than the first current intensity, the electrical voltage increases at most slightly with a further increase of the current intensity in the primary conductor,
wherein, when viewed in a pre-determinable electrical direction of rotation, the first winding voltage is positive and the second winding voltage is negative, and
wherein the electrical voltage for the electrical and/or electronic circuit is configured as the sum voltage of the positive first winding voltage and the negative second winding voltage.

20. The converter arrangement of claim 19, wherein from the pre-definable second current intensity the current intensity in the primary conductor remains substantially constant and/or becomes smaller with further continuous increase in the current intensity in the primary conductor.

21. The converter arrangement of claim 19, wherein the first winding voltage and the second winding voltage compensate for one another in such a manner that with varying current intensity in the primary conductor above the second current intensity, the electrical voltage varies by less than plus/minus 25 percent.

22. The converter arrangement of claim 19, configured in such a manner that at a nominal current intensity of the current intensity in the primary conductor a pre-definable nominal voltage of the electrical voltage is applied to terminals of the converter arrangement, wherein a maximum voltage corresponds to 1.1 times to 5 times the nominal voltage and wherein a ratio of the electrical nominal voltage to the electrical maximum voltage of the electrical voltage is pre-determined by a size of the air gap and by a ratio of a first number of turns of the first winding to a second number of turns of the second winding.

23. The converter arrangement of claim 22, wherein the maximum voltage corresponds to 1.2 times to 3 times the nominal voltage.

24. The converter arrangement of claim 22, wherein the maximum voltage corresponds to 1.3 times to 2 times the nominal voltage.

25. The converter arrangement of claim 19, configured for normal operation at a nominal current intensity in the primary conductor, with the nominal current intensity being greater than the first current intensity.

26. The converter arrangement of claim 25, wherein the nominal current intensity is greater than the second current intensity.

27. The converter arrangement of claim 19, wherein at a pre-definable current flow through the primary conductor the first magnetic circuit is configured to form a first magnetic flux, and the second magnetic circuit is configured to form a second magnetic flux which differs from the first magnetic flux.

28. The converter arrangement of claim 19, wherein the first magnetic circuit has a first magnetic total reluctance, and the second magnetic circuit has a second magnetic total reluctance which differs from the first magnetic total reluctance.

29. The converter arrangement of claim 28, wherein the second magnetic total reluctance is greater than the first magnetic total reluctance.

30. The converter arrangement of claim 19, wherein the first magnetic circuit has a first equivalent permeability, and the second magnetic circuit has a second equivalent magnetic permeability which differs from the first equivalent permeability.

31. The converter arrangement of claim 30, wherein the second equivalent magnetic permeability is smaller than the first equivalent permeability.

32. The converter arrangement of claim 19, wherein the first magnetic circuit comprises at least one first core element which is configured to enclose the primary conductor free in the absence of an air gap.

33. The converter arrangement of claim 19, wherein the second magnetic circuit comprises at least one second core element having the air gap, said second core element being configured to enclose the primary conductor with an air gap.

34. The converter arrangement of claim 19, wherein the air gap is configured to be between 0.01 mm and 0.5 mm wide.

35. The converter arrangement of claim 19, wherein the second magnetic circuit is located at a distance from the first magnetic circuit.

36. The converter arrangement of claim 19, wherein the second magnetic circuit comprises a partial region of the first magnetic circuit and a partial segment operatively connected to the partial region of the first magnetic circuit, wherein the first bushing and the second bushing are configured as a common bushing for the primary conductor.

37. The converter arrangement of claim 19, wherein, when viewed in a common direction of rotation of the first magnetic circuit about the first bushing and of the second magnetic circuit about the second bushing, in a pre-definable direction of current flow through the primary conductor the current flow of the first winding about a wound cross-section of the first magnetic circuit takes place in a first direction of rotation and the current flow of the second winding about a wound cross-section of the second magnetic circuit takes place in a second direction of rotation opposite to the first direction of rotation.

38. The converter arrangement of claim 19, wherein a ratio of a first number of turns of the first winding to a second number of turns of the second winding is between 2:1 and 1:2.

39. The converter arrangement of claim 38, wherein the first number of turns and the second number of turns are approximately the same.

40. The converter arrangement of claim 38, wherein the first number of turns is at least 20% lower than the second number of turns.

41. The converter arrangement of claim 19, wherein at least one of the first winding and the second winding is wound in a multipart manner.

42. The converter arrangement of claim 41, wherein the first winding is wound at least in two parts, and the second winding, when viewed in a direction of winding of a winding wire, is disposed between the two parts of the first winding.

43. The converter arrangement of claim 41, wherein the first winding is wound at least in three parts, and the second winding is wound at least in two parts, wherein, when viewed in a direction of winding of a winding wire, respectively at least one part of the second winding is disposed between respectively two parts of the first winding.

44. An electrical and/or electronic circuit, comprising a converter arrangement for generating an electrical voltage for an electrical and/or electronic circuit from a field of a current-carrying primary conductor, said converter arrangement comprising a first winding around a first magnetic circuit having a first bushing for the primary conductor, said first magnetic circuit being configured free from air gaps, wherein a first winding voltage can be formed in the first winding, a second winding disposed around a second magnetic circuit and connected in series with the first winding, said second magnetic circuit having a second bushing for the primary conductor and at least one air gap, wherein a second winding voltage can be formed in the second winding, wherein at a pre-definable current flow through the primary conductor the first winding voltage and the second winding voltage are configured to partially compensate for each other, wherein below a pre-definable first current intensity in the primary conductor the electrical voltage increases proportionally with increasing current intensity, and from a pre-definable second current intensity which is greater than the first current intensity, the electrical voltage increases at most slightly with a further increase of the current intensity in the primary conductor, wherein, when viewed in a pre-determinable electrical direction of rotation, the first winding voltage is positive and the second winding voltage is negative, and wherein the electrical voltage for the electrical and/or electronic circuit is configured as the sum voltage of the positive first winding voltage and the negative second winding voltage, said circuit being electrically supplied with voltage by the converter arrangement.

45. The electrical and/or electronic circuit of claim 44, configured as a circuit comprising an energy storage device.

46. The electrical and/or electronic circuit of claim 44, wherein the electrical voltage is provided as a measuring voltage and/or as a control voltage for the electrical and/or electronic circuits.

47. A switching device for interrupting a current flow, comprising an electrical and/or electronic circuit according to claim 44.

48. The switching device of claim 47, configured as a storage switching device.
